(19) United States
(12) Patent Application Publication
(10) Pub. No.: US 2026/0156391 A1
(43) Pub. Date: Jun. 4, 2026

(54) ACOUSTIC ARRAY FOR ACOUSTIC SOURCE LOCALIZATION AND ASSOCIATED SYSTEM AND METHOD

(71) Applicant: The Boeing Company, Arlington, VA (US)

(72) Inventors: Gail M. Barker, Seattle, WA (US); Bennett Smith, Seattle, WA (US); Bernard J. Sklanka, Maple Valley, WA (US); Xinyan Qiu, Seattle, WA (US); Joseph M. Fenske, Everett, WA (US); Katherine Pennella, Everett, WA (US); Paul R. Davies, Long Beach, CA (US)

(21) Appl. No.: 18/964,069

(22) Filed: Nov. 29, 2024

(51) Int. Cl. H04R 1/02; G01S 5/20; H04R 1/08

(52) U.S. Cl. CPC H04R 1/02; G01S 5/20; H04R 1/08

(57) ABSTRACT

Disclosed herein is an acoustic array and associated system and method for acoustic source localization. The acoustic array includes a plurality of microphones, each positioned along at least one of a first axis, a second axis angled relative to the first axis, or a third axis, angled relative to the first axis and the second axis. The acoustic array further includes a support assembly having a central mount and a plurality of support arms that extend outward from the central mount. Each one of the plurality of microphones are coupled to either the central mount or one of the plurality of support arms, enabling precise localization of acoustic sources within an acoustic-testing space.

### FIELD

This disclosure relates generally to acoustic signal detection and localization and more particularly to an acoustic array and associated system and method for localizing an acoustic source.

### BACKGROUND

Unexpected sounds in various environments, such as aircraft cabins, automotive interiors, or industrial settings, may indicate mechanical issues or other malfunctions. Identifying the precise location and source of a sound may be important for diagnosing and resolving potential problems, but doing so can be challenging due to the complexity and size of these environments.

Often, relying solely on hearing or descriptions from individuals present during the event is insufficient, as sound can be distorted by reflections, absorbed by materials, or otherwise difficult to pinpoint. Accordingly, in some environments, such as aircraft, it is common practice to separately install multiple microphones, and, in some cases, accelerometers, throughout the aircraft and repeat the relevant flight operation in an attempt to replicate and locate the source of the noise. However, this approach is time-consuming, requires significant setup, and often lacks precision due to its reliance on basic comparisons of sound and vibration levels, without the use of advanced signal-processing techniques.

### SUMMARY

The subject matter of the present application has been developed in response to the present state of the art, and in particular, in response to the shortcomings of acoustic source localization, that have not yet been fully solved by currently available techniques. Accordingly, the subject matter of the present application has been developed to provide an acoustic array for acoustic source localization and associated system and method that overcome at least some of the above-mentioned shortcomings of prior art techniques.

The following is a non-exhaustive list of examples, which may or may not be claimed, of the subject matter, disclosed herein.

Disclosed herein is an acoustic array for acoustic source localization. The acoustic array includes a plurality of microphones and a support assembly. Each one of the plurality of microphones is positioned along at least one of a first axis, a second axis angled relative to the first axis, or a third axis angled relative to the first axis and the second axis. A first microphone of the plurality of microphones is positioned at an origin of the acoustic array defined at an intersection of the first axis, the second axis, and the third axis. Others of the plurality of microphones are positioned at a predetermined distance from the origin, with at least one of the plurality of microphones positioned along each one of the first axis, the second axis, and the third axis. The support assembly includes a central mount and a plurality of support arms that extend outward from the central mount. Each one of the plurality of microphones are coupled to either the central mount or one of the plurality of support arms. Ones of the plurality of microphones coupled to the central mount are positioned along the first axis. Ones of the plurality of microphones coupled to a corresponding one of the plurality of support arms are positioned along the second axis or the third axis. The preceding subject matter of this paragraph characterizes example 1 of the present disclosure.

The plurality of support arms includes a first support arm and a second support arm. The ones of the plurality of microphones coupled to the first support arm are positioned along the second axis. The ones of the plurality of microphones coupled to the second support arm are positioned along the third axis. The preceding subject matter of this paragraph characterizes example 2 of the present disclosure, wherein example 2 also includes the subject matter according to example 1, above.

The plurality of support arms includes four support arms. A first pair of the four support arms extends outward from the central mount such that the ones of the plurality of microphones coupled to the first pair of the four support arms are positioned along the second axis on opposing sides of the origin. A second pair of the four support arms extends outward from the central mount such that the ones of the plurality of microphones coupled to the second pair of the four support arms are positioned along the third axis on opposing sides of the origin. The preceding subject matter of this paragraph characterizes example 3 of the present disclosure, wherein example 3 also includes the subject matter according to any of examples 1-2, above.

Each one of the plurality of support arms is foldable relative to the central mount, such that the plurality of support arms are selectively movable between, and inclusive of, an extended position and a folded position. When the plurality of support arms are in the extended position, the ones of the plurality of microphones coupled to the plurality of support arms are positioned along the second axis or the third axis. When the plurality of support arms are in the folded position, the ones of the plurality of microphones coupled to the plurality of support arms are not positioned along the second axis or the third axis. The preceding subject matter of this paragraph characterizes example 4 of the present disclosure, wherein example 4 also includes the subject matter according to any of examples 1-3, above.

A length of each one of the plurality of support arms is adjustable to adjust the predetermined distance of a corresponding one of the plurality of microphones from the origin. The preceding subject matter of this paragraph characterizes example 5 of the present disclosure, wherein example 5 also includes the subject matter according to any of examples 1-4, above.

The first axis is orthogonal to the second axis and the third axis is orthogonal to both the first axis and the second axis. The preceding subject matter of this paragraph characterizes example 6 of the present disclosure, wherein example 6 also includes the subject matter according to any of examples 1-5, above.

The predetermined distance between the first microphone, positioned at the origin, and each one of the others of the plurality of microphones is the same. The preceding subject matter of this paragraph characterizes example 7 of the present disclosure, wherein example 7 also includes the subject matter according to any of examples 1-6, above.

The plurality of microphones includes seven microphones, including the first microphone positioned at the origin. A first pair of microphones is positioned along the first axis on opposing sides of the origin. A second pair of microphones is positioned along the second axis on opposing sides of the origin. A third pair of microphones is positioned along the third axis on opposing sides of the origin. The preceding subject matter of this paragraph characterizes example 8 of the present disclosure, wherein example 8 also includes the subject matter according to any of examples 1-7, above.

The plurality of microphones are configured to provide directional acoustic coverage in at least one octant defined by the intersection of three planes formed by the first axis, the second axis, and the third axis. The preceding subject matter of this paragraph characterizes example 9 of the present disclosure, wherein example 9 also includes the subject matter according to any of examples 1-8, above.

The plurality of microphones are configured to provide directional acoustic coverage in all directions to provide full spherical coverage. The preceding subject matter of this paragraph characterizes example 10 of the present disclosure, wherein example 10 also includes the subject matter according to any of examples 1-9, above.

The plurality of microphones includes at least one secondary microphone positioned along at least one of the first axis, the second axis, or the third axis, on a same side of the origin, at a second predetermined distance from the origin, as another one of the plurality of microphones, and wherein the second predetermined distance is different than the predetermined distance. The preceding subject matter of this paragraph characterizes example 11 of the present disclosure, wherein example 11 also includes the subject matter according to any of examples 1-10, above.

Further disclosed herein is an acoustic source localization system that includes an acoustic array, a data acquisition module, and an analysis module. The acoustic array includes a plurality of microphones and a support assembly configured to couple each one of the plurality of microphones along at least one of a first axis, a second axis angled relative to the first axis, or a third axis angled relative to the first axis and the second axis. A first microphone of the plurality of microphones is positioned at an origin of the acoustic array defined at an intersection of the first axis, the second axis, and the third axis. Others of the plurality of microphones are positioned at a predetermined distance from the origin, with at least one of the plurality of microphones positioned along each one of the first axis, the second axis, and the third axis. The data acquisition module is operatively coupled to the plurality of microphones and configured to receive and record acoustic signals from the acoustic source. The acoustic signals are captured by each one of the plurality of microphones and recorded as recorded acoustic signals. The analysis module is configured to process the recorded acoustic signals from the data acquisition module and determine a location of the acoustic source based on the recorded acoustic signals. The location includes a directional vector and a distance, relative to the origin of the acoustic array. The preceding subject matter of this paragraph characterizes example 12 of the present disclosure.

The acoustic source localization system also includes a visualization module that is configured to display a graphical representation of the location of the acoustic source. The preceding subject matter of this paragraph characterizes example 13 of the present disclosure, wherein example 13 also includes the subject matter according to example 12, above.

The visualization module includes visualization data representing an acoustic-testing space where the acoustic array is configured to be deployed. The visualization module is configured to display the graphical representation of the location of the acoustic source relative to the visualization data. The preceding subject matter of this paragraph characterizes example 14 of the present disclosure, wherein example 14 also includes the subject matter according to example 13, above.

The visualization data includes a virtual representation of the acoustic-testing space, allowing the visualization data to be observed by a user located remotely from the acoustic-testing space. The visualization module is configured to display the graphical representation of the location of the acoustic source relative to the virtual representation of the acoustic-testing space. The preceding subject matter of this paragraph characterizes example 15 of the present disclosure, wherein example 15 also includes the subject matter according to example 14, above.

The visualization data includes a real-time view of the acoustic-testing space, allowing the visualization data to be observed by a user. The visualization module is configured to display the graphical representation of the location of the acoustic source relative to the real-time view of the acoustic-testing space. The preceding subject matter of this paragraph characterizes example 16 of the present disclosure, wherein example 16 also includes the subject matter according to example 14, above.

The analysis module is configured to determine the location of the acoustic source using one or more signal-processing algorithms, based on the recorded acoustic signals captured by the plurality of microphones. The one or more signal-processing algorithms include at least one of a time-of-arrival algorithm or a phased array beamforming algorithm. The preceding subject matter of this paragraph characterizes example 17 of the present disclosure, wherein example 17 also includes the subject matter according to any of examples 12-16, above.

The analysis module is configured to identify a localized octant where the acoustic source is located, based on the acoustic signals received from each one of the plurality of microphones positioned along the first axis, the second axis, and the third axis, identify a subset of the plurality of microphones that defines the localized octant, and determine the location of the acoustic source within the localized octant, using one or more signal-processing algorithms, based on the recorded acoustic signals captured by the subset of the plurality of microphones. The one or more signal-processing algorithms include at least one of a time-of-arrival algorithm or a phased array beamforming algorithm. The preceding subject matter of this paragraph characterizes example 18 of the present disclosure, wherein example 18 also includes the subject matter according to any of examples 12-17, above.

The analysis module is configured to analyze the recorded acoustic signals to determine a sound characteristic of the recorded acoustic signals. The sound characteristic is one of a periodic sound source or a non-periodic sound source. The analysis module is also configured to select and apply one or more signal-processing algorithms based on the sound characteristic. At least one of the one or more signal-processing algorithms is configured for periodic sound sources and at least another one of the one or more signal-processing algorithms is configured for non-periodic sound sources. The preceding subject matter of this paragraph characterizes example 19 of the present disclosure, wherein example 19 also includes the subject matter according to any of examples 12-18, above.

Further disclosed herein is a method for localizing an acoustic source. The method includes receiving acoustic signals from the acoustic source, captured by a plurality of microphones positioned along each one a first axis, a second axis angled relative to the first axis, and a third axis angled relative to both the first axis and the second axis. The plurality of microphones are coupled to a support assembly of an acoustic array. The method also includes recording the acoustic signals, captured by the plurality of microphones as recorded acoustic signals. The method further includes analyzing the recorded acoustic signals to determine positional information of the acoustic source relative to an origin defined by the intersection of the first axis, the second axis, and the third axis. Additionally, the method includes determining a location of the acoustic source based on the positional information. The preceding subject matter of this paragraph characterizes example 20 of the present disclosure.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a schematic perspective view of one example of an acoustic array, with four support arms, according to one or more examples of the present disclosure;

FIG. 2 is a schematic perspective view of one example of an acoustic array, with two support arms, according to one or more examples of the present disclosure;

FIG. 3A is a schematic perspective view of an acoustic array, with support arms in an extended position, according to one or more examples of the present disclosure;

FIG. 3B is a schematic perspective view of the acoustic array of FIG. 3A, with support arms in a folded position, according to one or more examples of the present disclosure;

FIG. 4 is a schematic perspective view of one example of an acoustic array, with support arms having an adjustable length, according to one or more examples of the present disclosure;

FIG. 5 is a schematic perspective view of one example of an acoustic array, with multiple microphones positioned along a same axis and side relative to an origin, according to one or more examples of the present disclosure;

FIG. 6A is a schematic perspective view of one example of an acoustic array, providing directional acoustic coverage in a single octant, according to one or more examples of the present disclosure;

FIG. 6B is a schematic perspective view of one example of an acoustic array, providing directional acoustic coverage with full spherical coverage, according to one or more examples of the present disclosure;

FIG. 7 is a schematic box diagram of an acoustic source localization system, according to one or more examples of the present disclosure;

FIG. 8 is a schematic perspective view of a visualization module of the acoustic source localization system of FIG. 7, according to one or more examples of the present disclosure;

FIG. 9 is a schematic box diagram of an analysis module of the acoustic source localization system of FIG. 7, according to one or more examples of the present disclosure; and

FIG. 10 is a schematic flow chart of a method of localizing an acoustic source, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Disclosed herein is an acoustic array and associated system and method, for localizing an acoustic source (e.g., sound). The acoustic array is configured to provide directional acoustic coverage within an acoustic-testing space for localization of an acoustic source within the acoustic-testing space, particularly when the sound is unexpected or abnormal. Specifically, the acoustic array captures sound (i.e., acoustic signals) from multiple directions using a plurality of microphones that are each coupled to a support assembly. These microphones are positioned along at least one of three axes, allowing the acoustic array to accurately determine the location of the acoustic source by analyzing the acoustic signals received by each microphone, enabling identification and any necessary corrective actions within the acoustic-testing space based on the identified acoustic source.

The acoustic array enhances efficiency of sound localization by analyzing the arrival of sound across the microphones, offering a method for pinpointing noise origins in complex environments. Signal-processing algorithms, such as time-of-arrival or phased array beamforming, can be used to determine the location of the sound. Designed to be compact and easy to set up, the acoustic array eliminates the need to attach individual microphones to various surfaces within the acoustic-testing space. This reduces setup time compared to conventional methods, which often require installing multiple microphones and, in sometimes accelerometers, throughout the acoustic-testing space. Once the acoustic signals are captured, the signals can be analyzed using advanced signal processing methods, allowing users without specialized signal processing knowledge to quickly and accurately pinpoint the source of unexpected sounds. While the acoustic array is described here in the context of use within an aircraft cabin, it has broad application in other industries such as automotive or industrial environments, where rapid identification of sound sources is important for maintenance and troubleshooting.

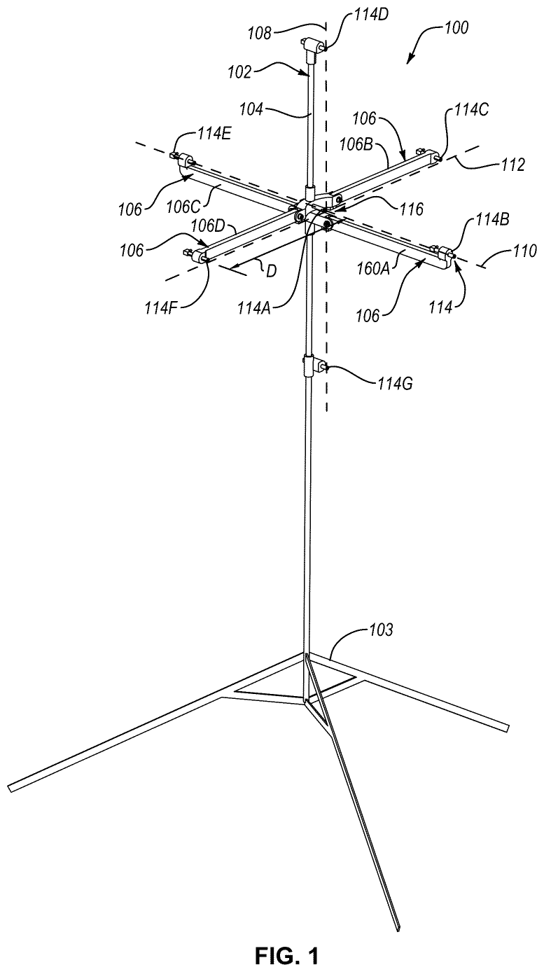

According to some examples, an acoustic array 100 is shown in FIG. 1. The acoustic array 100 is configured for localizing an acoustic source within a given acoustic-testing space. As used herein, an acoustic source refers to any sound-generating object or event, which may produce unexpected or abnormal sounds such as mechanical noise, leaks, airflow disturbances, vibrations, etc. The acoustic source may be a periodic sound source, which generates sounds in a regular, repeating pattern (e.g., machinery with consistent rotational motion or engine noise), or a non-periodic sound source, which produces irregular or random sounds (e.g., an intermittent mechanical fault). Additionally, as used herein, an acoustic-testing space may refer to any environment in which acoustic localization is required, including but not limited to aircraft interiors, automotive interiors, industrial facilities, or laboratory settings.

The acoustic array 100 includes a plurality of microphones 114. Each one of the plurality of microphones 114 is positioned along at least one of three axes, including a first axis 108, a second axis, 110, and a third axis 112. The three axes are angled relative to each other. In some examples, each one of the three axes is orthogonal to any other one of the three axes. That is, the second axis 110 is orthogonal to the first axis 108, and the third axis 112 is orthogonal to the first axis 108 and the second axis 110, thus forming a three-dimensional coordinate system for sound localization. Orthogonal axes are useful for maximizing the distance between microphones for each axis, which increases the spatial resolution and accuracy in detecting time-of-arrival differences for sound localization. Additionally, the arrangement also simplifies the calculations needed for determining the acoustic source location, as it allows for more precise measurements and faster processing due to the clear separation of sound directions along each axis. In other examples, the three axes may be non-orthogonal, but still intersect at a common origin, which enables the plurality of microphones 114 to be positioned in alternative configurations to suit specific testing environments. Non-orthogonal axes can be useful in constrained or complex environments, where strict orthogonal spacing is not feasible.

A first microphone 114A of the plurality of microphones 114 is positioned at an origin 116 of the acoustic array 100. The origin 116 is defined as the intersection of the first axis 108, the second axis 110, and the third axis 112. The remaining ones of the plurality of microphones 114 are positioned at a predetermined distance (D) from the origin 116, with at least one of the plurality of microphones 114 positioned along each one of the first axis 108, the second axis 110, and the third axis 112. The predetermined distance (D) determines the sensitivity of the acoustic array 100 and the frequency range of the acoustic signals to be detected. For higher frequencies, the microphones may be positioned closer together to avoid spatial aliasing, while for lower frequencies, the microphones may be positioned further apart. The predetermined distance (D) may vary based on the size or the specific requirements of the acoustic-testing space. In some examples, the predetermined distance (D) between the first microphone 114A, positioned at the origin 116, and each one of the others of the plurality of microphones 114 is the same. In other examples, the predetermined distance (D) between at least one of the plurality of microphones 114 and the first microphone 114A is different from others of the plurality of microphones 114.

The plurality of microphones 114 are arranged into independent pairs, where each pair includes the first microphone 114A, positioned at the origin 116, and a second microphone positioned along one of the axes (e.g., the first axis 108, the second axis 110, or the third axis 112). For example, the first microphone 114A is paired with a microphone (e.g., 114D) along the first axis 108, the first microphone 114A is paired with another microphone (e.g. 114B) along the second axis 110, and the first microphone 114A is paired with a yet another microphone (e.g., 114C) along the third axis 112. These pairs of microphones are used to calculate time of the sound arrival, which contributes to determining the direction and location of the acoustic source, as will be described in more detail below.

The acoustic array 100 also includes a support assembly 102, which provides structural support and ensures the proper positioning of the plurality of microphones 114 along their designated axes. The support assembly 102 includes a central mount 104 and a plurality of support arms 106 that extend outward from the central mount 104. The central mount 104 serves as the primary connection point for each one of the plurality of support arms 106 and is configured to couple certain ones of the plurality of microphones 114 along the first axis 108. The plurality of support arms 106 are configured to couple others of the plurality of microphones 114 along the second axis 110 and the third axis 112. In some examples, the central mount 104 and the plurality of support arms 106 may be directly aligned with the axes. More specifically, in these examples, the central mount 104 aligns the first axis 108, at least one of the plurality of support arms 106 aligns the second axis 110, and at least another one of the plurality of support arms 106 aligns the third axis 112. This configuration applies when the plurality of microphones 114 are directly attached to the central mount 104 and the plurality of support arms 106 along the respective axes. Alternatively, in other examples, the central mount 104 and the plurality of support arms 106 may support the plurality of microphones 114 at positions extending outward from the support assembly 102, such as shown in FIG. 1. In these cases, the support assembly 102 holds the plurality of microphones 114 at a distance from the central mount 104 or the plurality of support arms 106, with the microphones attached to the ends of extension arms, allowing the microphones to extend beyond the immediate structure of the support assembly 102. Accordingly, the first axis 108, the second axis 110, and the third axis 112 are defined by the placement of the plurality of microphones 114, rather than the support assembly 102 itself. In other words, while the support assembly 102 does not necessarily need to align directly with the axes, it ensures the microphones are arranged along the axes for accurate acoustic source localization.

It is important that the positions of the axes and the plurality of microphones 114 along those axes are known and accurately mapped for accurate acoustic source localization. In this context, “known” means that the spatial coordinates and orientation of each microphone are predefined and can be precisely referenced during signal processing. This allows the acoustic source localization system, described below, to accurately calculate the time differences in sound arrival between the microphones and the acoustic source. In some examples, the alignment of the axes may be a true vertical and horizontal orientation, such that the first axis 108 may be aligned vertically, corresponding to a z-axis, while the second axis 110 and the third axis 112 may be aligned horizontally, corresponding to the x-axis and the y-axis, as shown in FIG. 1. In other examples, the alignment of the axes does not need to be restricted to vertical or horizontal directions.

Additionally, in some examples, the support assembly 102 includes a support base 103 that is configured to support the support assembly 102 in an elevated position relative to a ground surface of the acoustic-testing space. As shown in FIG. 1, in some examples, the support base 103 may include multiple legs that extend outward, forming a tripod-like structure that ensures the acoustic array 100 remains stable during operation, however other configurations may also be used. The support base 103 may be collapsible or adjustable to accommodate various acoustic-testing spaces, which enables easier transport and setup of the acoustic array 100.

In some examples, the support assembly 102 includes four support arms, including a first support arm 106A, a second support arm 106B, a third support arm 106C, and a fourth support arm 106D. A first pair of the four support arms includes the first support arm 106A and the third support arm 106C, which are laterally aligned on opposing sides of the origin 116, relative to the second axis 110. A second pair of the four support arms includes the second support arm 106B and the fourth support arm 106D, which are similarly positioned on opposing sides of the origin 116 relative to the third axis 112. Specifically, the plurality of microphones 114 coupled to the first pair are positioned along the second axis 110, such that each microphone is located at either a positive or negative position relative to the origin (e.g., +X axis coordinate or −X axis coordinate). Likewise, the plurality of microphones 114 coupled to the second pair are positioned along the third axis 112, such that each microphone is located at either a positive or negative position relative to the origin (e.g., +Y axis coordinate or −Y axis coordinate). Similarly, microphones positioned along the first axis 108, are arranged at a positive or negative position relative to the origin (e.g., +Z axis coordinate or −Z axis coordinate).

The plurality of microphones 114 used in the acoustic array 100 are configured for accurate and efficient acoustic source localization. The plurality of microphones 114 may be omni-directional or nearly omni-directional microphones, which can be important for installations where the direction of the acoustic source is not known in advance. This allows the microphones to capture sound equally well from all directions. In scenarios where the general direction of the acoustic source is known, microphones with a cardioid pattern may be used, with a dead-zone of the microphone directed away from the expected location of the acoustic source to minimize unwanted noise. Additionally, the microphones may be instrumentation-quality, which ensures high sensitivity and the ability to convert acoustic pressure into voltage signals with high signal-to-noise ratios. This sensitivity is particularly important in noisy environments such as aircraft cabins, where background noise levels are high, and clear signal detection is useful. Further, the microphones may have a wide frequency response capable of capturing a broad spectrum of acoustic sources, such as low-frequency vibrations to high-pitched mechanical sounds. For example, the generally flat frequency range of the plurality of microphones 114 may be between and inclusive of 15 Hz to 20 kHz.

As shown in FIG. 1, in some examples, the plurality of microphones 114 of the acoustic array 100 includes seven microphones. The seven microphones include the first microphone 114A, positioned at the origin 116, a second microphone 114B, positioned along the second axis (e.g., +X axis coordinate), a third microphone 114C, positioned along the third axis (e.g., +Y axis coordinate), a fourth microphone 114D, positioned along the first axis (e.g., +Z axis coordinate), a fifth microphone 114E, positioned along the second axis (e.g., −X axis coordinate), a sixth microphone 114F, positioned along the third axis (e.g., −Y axis coordinate), and a seventh microphone 114G, positioned along the first axis (e.g., −Z axis coordinate). Accordingly, some of the plurality of microphones 114 are positioned along the first axis 108 on opposing sides of the origin 116, other ones of the plurality of microphones 114 are positioned along the second axis 110 on opposing sides of the origin 116, and yet other ones of microphones 114 are positioned along the third axis 112 on opposing sides of the origin 116.

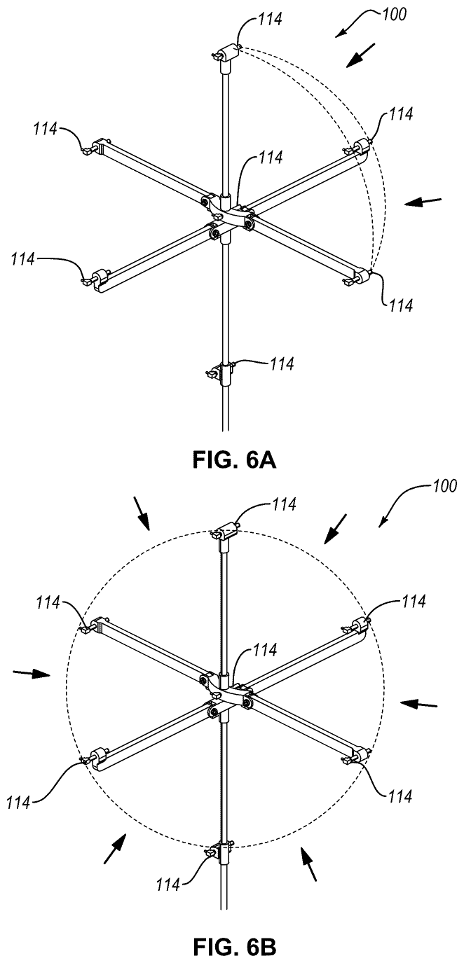

The arrangement of the seven microphones 114 along the first axis 108, the second axis 110, and the third axis 112 is designed to provide directional acoustic coverage in all directions, as shown in FIG. 6B. By placing the microphones along each axis and on opposing sides of the origin 116, the acoustic array 100 can detect acoustic sources from any angle within the acoustic-testing space. Specifically, the placement along three orthogonal axes enables the acoustic array 100 to capture sound from 360 degrees around the origin 116, effectively providing full spherical coverage. This configuration enables the system to pinpoint the location of an acoustic source with high accuracy, regardless of its direction relative to the acoustic array 100.

In certain examples, the acoustic array 100 provides a focused directional coverage, such that the acoustic array 100 is configured to capture sound only from certain angles or sectors. This configuration may be used when the general location of the acoustic source is already known, allowing the acoustic array 100 to focus its detection within a particular area of interest. By reducing the field of coverage, the acoustic source localization system may improve its sensitivity and accuracy within the focused area, and filter out noise and irrelevant signals from outside the target zone. This type of sectoral coverage can be achieved by selective placement or orientation of the plurality of microphones, inactivating certain ones of the plurality of microphones, or using directional microphones with cardioid or hypercardioid patterns that selectively capture sound from specific directions. Such a configuration may be advantageous in situations where the source of the sound is confined to a particular section of the acoustic-testing space.

In some cases, the acoustic array 100 may be configured to provide directional coverage in at least one octant. An octant refers to one of the eight divisions of three-dimensional space created by the three intersecting axes: the first axis 108, the second axis 110, and the third axis 112. Each octant is bounded by the positive or negative directions of these three axes, effectively dividing the space into eight distinct sections relative to the origin. In other words, an octant is defined by the intersection of three planes formed by the first axis 108, the second axis 110, and the third axis 112, as shown in FIG. 6A. By focusing on a specific octant, the acoustic array 100 can be used to localize sound within a more defined region, such as in scenarios where the acoustic source is known to be in a particular section of the acoustic-testing space. This type of focused coverage can reduce the computational complexity of the localization process, as the acoustic source localization system only needs to analyze signals within the selected octant, leading to faster and more efficient processing. Additionally, octant coverage can improve precision in environments where sound reflections or background noise from other sections of the acoustic-testing space might interfere with the localization process.

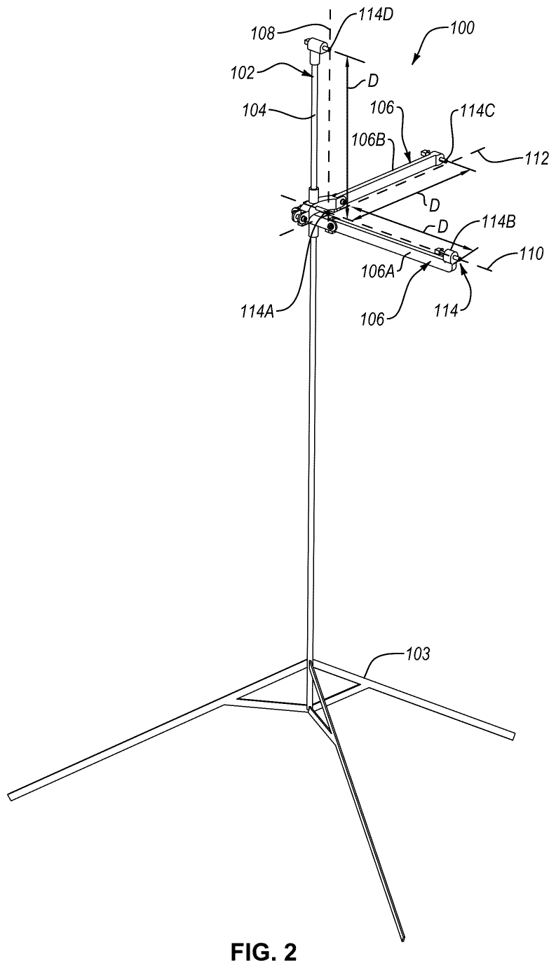

In order to test within a specific octant(s), the acoustic array 100 may have fewer than the four support arms shown in FIG. 1. For example, in some examples, as shown in FIG. 2, the acoustic array 100 includes two support arms. A first support arm 106A extends from the central mount 104 and is aligned relative to the second axis 110, while a second support arm 106B extends from the central mount 104 and is aligned relative to the third axis 112. Accordingly, a first microphone 114A is positioned at the origin 116, a second microphone 114B is positioned along the second axis 110, a third microphone 114C is positioned along the third axis 112, and a fourth microphone 114D is positioned along the first axis 108. Although shown with the plurality of microphones 114 positioned in the positive directions along each axis, any combination of support arms and microphones may be included to cover any desired octant(s).

Accordingly, in some examples, the plurality of microphones 114 of the acoustic array 100 may include, at a minimum, four microphones. The four microphones include the first microphone 114A, the second microphone 114B, the third microphone 114C, and the fourth microphone 114D, where one microphone is positioned at the origin 116 and the remaining microphones are positioned in each one of the three axes. Using at least four microphones, any octant(s) can be covered with directional acoustic coverage.

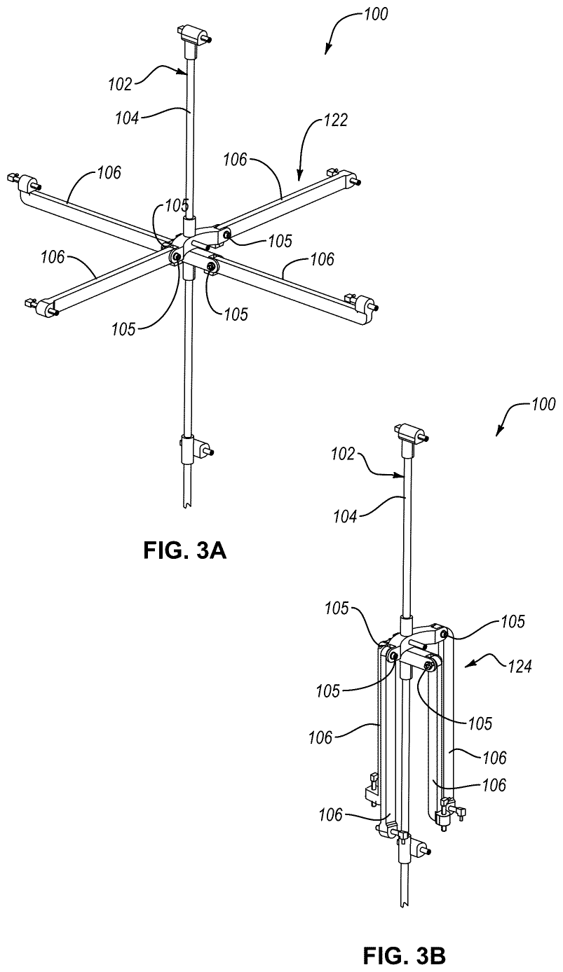

As shown in FIGS. 3A and 3B, in some examples, the acoustic array 100 has a foldable design. Referring to FIG. 3A, the acoustic array 100 is shown in an extended position 122, where the plurality of support arms 106 are extended, relative to the central mount 104. In the extended position 122, the plurality of microphones 114 are positioned within at least one of the first axis 108, the second axis 110, and the third axis 112. Each one of the plurality of support arms 106 include a hinged joint 105 that allows the support arm 106 to be folded inward towards the central mount 104.

Referring to FIG. 3B, the acoustic array 100 is shown in a folded position 124, where each one of the plurality of support arms 106 is rotated inwardly around the hinged joint 105. In the folded position 124, the plurality of support arms 106 are compactly arranged adjacent to the central mount 104, allowing for easier transport and storage of the acoustic array 100 compared to when the acoustic array 100 is in the extended position 122. Additionally, in the folded positioned 124, the plurality of microphones 114 coupled to the plurality of support arms 106 and are no longer positioned along the second axis 110 and the third axis 112. While the plurality of support arms 106 are shown folded downward toward to the central mount 104, the plurality of support arm 106 could also be configured to fold upward. The foldable design ensures the acoustic array 100 can be efficiently deployed in tight spaces or transported between acoustic-testing spaces. Additionally, the foldable configuration helps protect the plurality of microphones 114 during transport, reducing the risk of damage. In some examples, the hinged joint 105 is configured to lock into both the extended position 122 and the folded position to ensure stability during use and transport. When locked into the extended position 122, the plurality of support arms 106 maintain their alignment relative to the respective axes. When locked into the folded position 124, the plurality of support arms 106 remain securely folded for safe handling and storage.

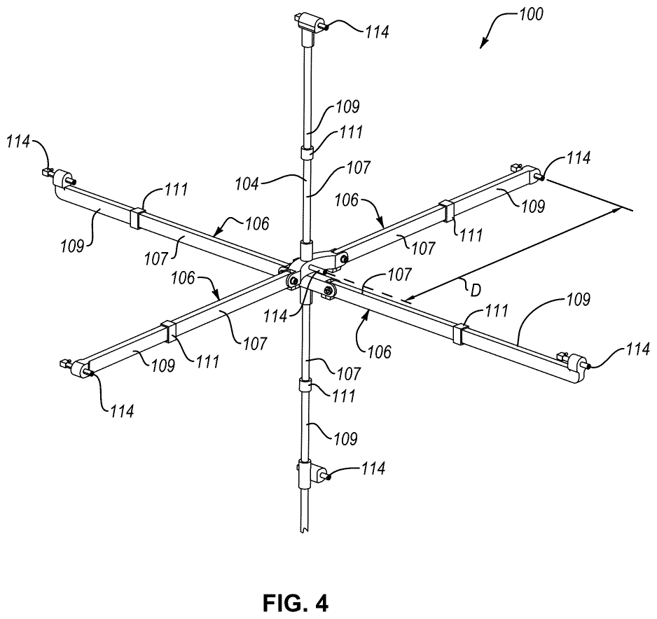

In some examples, the acoustic array 100 may have expandable support arms. That is, a length of each one of the plurality of support arms 106 may be adjustable to adjust the predetermined distance (D) of a corresponding one of the plurality of microphones 114 from the origin 116. As shown in FIG. 4, each one of the plurality of support arms 106 includes an expansion bracket 111, which allows a second arm portion 109 to be expanded or retracted relative to a first arm portion 107. Adjusting the position of the second arm portion 109 relative to the first arm portion 107 changes the predetermined distance (D) of the corresponding microphone from the origin 116. By altering the predetermined distance (D), the acoustic array 100 can adjust the sensitivity of selected ones of the plurality of microphones 114 to different frequencies or ranges. For example, increasing the predetermined distance (D) between the microphone pairs can enhance the acoustic array's 100 ability to detect lower-frequency sounds with longer wavelengths, while decreasing the predetermined distance (D) may improve detection of higher-frequency sounds with shorts wavelengths. The adjustability allows the acoustic array 100 to be fine-tuned for various acoustic-testing spaces and applications, depending on the range of frequencies that need to be detected or localized. The central mount 104 may also have expandable functionality allowing the microphones 114 along the first axis 108 to be adjusted.

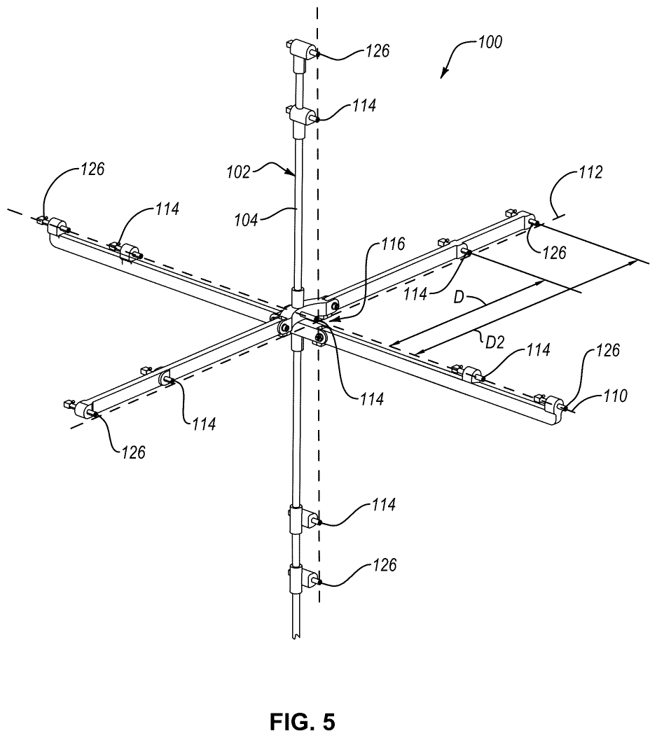

Additionally, or alternatively, in some examples, the acoustic array 100 may include at least one secondary microphone 126 positioned along at least one of the first axis 108, the second axis 110, or the third axis 112 at a second predetermined distance (D2). In other words, at least one of the plurality of support arms 106 has a microphone at the predetermined distance (D) and a secondary microphone at the second predetermined distance (D2) on a same side of the origin 116. The second predetermined distance (D2) is different from the predetermined distance (D). As shown in FIG. 5, each one of the plurality of support arms 106 includes a secondary microphone 126. The addition of the secondary microphones 126, in conjunction with the primary microphones positioned at the predetermined distance (D), allows the acoustic array 100 to capture acoustic signals over a broader range. Specifically, by incorporating microphones at different distances from the origin 116, the acoustic array 100 can enhance its sensitivity to a wider range of frequencies and improve its ability to detect acoustic sources at varying distances. For example, the primary microphones positioned at the predetermined distance (D) may be optimized for higher-frequency acoustic detection, while the secondary microphones 126 positioned at the second predetermined distance (D2) may be better suited for detecting lower-frequency sounds. This configuration increases the overall adaptability of the acoustic array 100, allowing it to provide accurate acoustic localization across a broader spectrum of frequencies and from sources at varying distances within the acoustic-testing space. The central mount 104 may also have secondary microphones 126 positioned along the first axis 108.

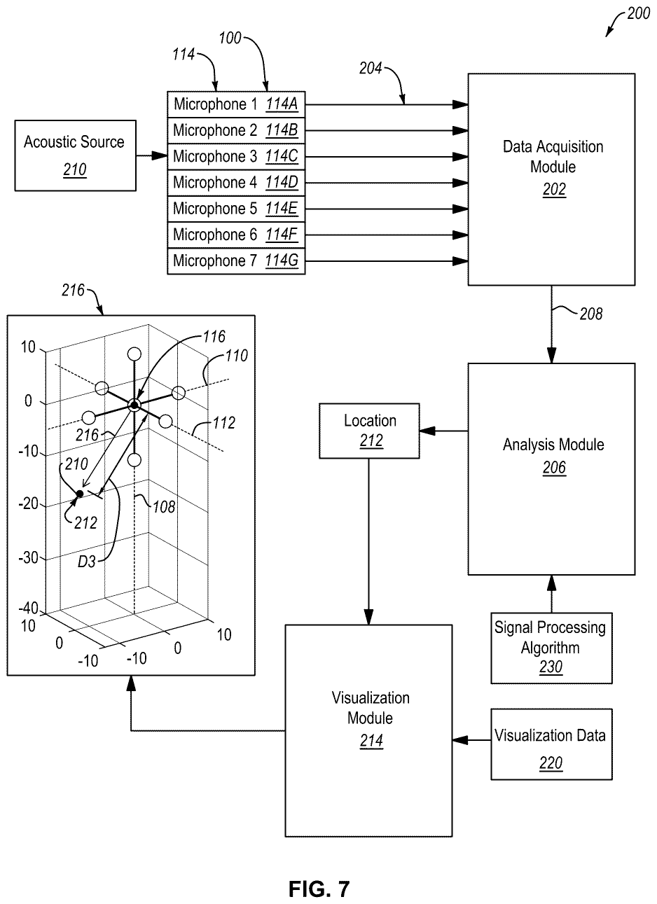

Referring to FIG. 7, one example of an acoustic source localization system 200 is shown. The acoustic source localization system 200 includes the acoustic array 100, a data acquisition module 202 and an analysis module 206. The acoustic source localization system 200 is configured to detect, capture, and process acoustic signals from any of various sources within an acoustic-testing space. In some examples, the acoustic source localization system 200 also includes a visualization module 214, which may provide a real-time or post-processed representation of the detected acoustic source. Together, these components allow the acoustic source localization system 200 to efficiently and accurately determine the location of an acoustic source.

Accordingly, the acoustic source localization system 200 is configured to detect and localize an acoustic source 210, which may include various types of sound-generating events, such as mechanical noises, vibrations, or environmental sounds. The acoustic source 210 is within an acoustic-testing space, where the sound it generates is captured by the plurality of microphones 114 of the acoustic array 100, as described above. Each one of the plurality of microphones 114 is positioned strategically within the acoustic array 100 to capture acoustic signals from different directions. For example, the acoustic array 100 may include seven microphones, as shown in FIG. 7, which include the first microphone 114A, the second microphone 114B, the third microphone 114C, the fourth microphone 114D, the fifth microphone 114E, the sixth microphone 114F, and the seventh microphone 114G. However, in other examples, the acoustic array 100 may include more or fewer than the seven microphones shown. The arrangement of the plurality of microphones 114 allows the acoustic source localization system 200 to create a comprehensive acoustic profile of the space around the acoustic source 210.

As sound waves (e.g., acoustic signals) propagate from the acoustic source 210, each one of the plurality of microphones 114 captures the signals in real-time and transmits the data to the data acquisition module 202 via signal paths as acoustic signals 204. These acoustic signals 204 include essential information such as the time of arrival and the amplitude of the sound waves at the corresponding one of the plurality of microphones 114.

The data acquisition module 202 is operatively coupled to each one of the plurality of microphones 114 and is configured to receive and record the acoustic signals 204 generated by the acoustic source 210. As the plurality of microphones 114 capture the acoustic signals 204, the acoustic signals 204 are transmitted to the data acquisition module 202 in real-time. The data acquisition module 202 processes the acoustic signals 204 by converting them into recorded acoustic signals 208, which serve as a digital representation of the acoustic waves detected by each one of the plurality of microphones 114.

The data acquisition module 202 is designed to handle multiple channels of acoustic data simultaneously, with each one of the plurality of microphones 114 sending its corresponding acoustic signal 204 to the module. This allows the data acquisition module 202 to generate a comprehensive set of recorded acoustic signals 208, capturing both the time delay and the amplitude of the sound at each microphone. The recorded acoustic signals 208 provide the necessary data for further analysis.

The analysis module 206 is configured to process the recorded acoustic signals 208 received from the data acquisition module 202 and determine the location 212 of the acoustic source 210. Specifically, the analysis module 206 utilizes the time delays and acoustic data from each one of the plurality of microphones 114 to calculate the position of the acoustic source 210. The analysis module 206 determines the location 212 by calculating both a direction vector 218 and a distance (D3) relative to the origin 116 of the acoustic array 100. The directional vector 218 provides the angle or direction of the acoustic source 210 in relation to the acoustic array 100, while the distance (D3) represents how far the acoustic source 210 is from the origin 116. Together, the directional vector 218 and the distance (D3) enable precise localization of the acoustic source 210 within the acoustic-testing space.

In order to determine the location 212, the analysis module 206 applies advanced signal processing techniques to interpret the recorded acoustic signals 208, which accounts for factors such as sound reflection, interference, and background noise. By leveraging these calculations, the analysis module 206 is capable of generating accurate three-dimensional coordinates of the acoustic source 210.

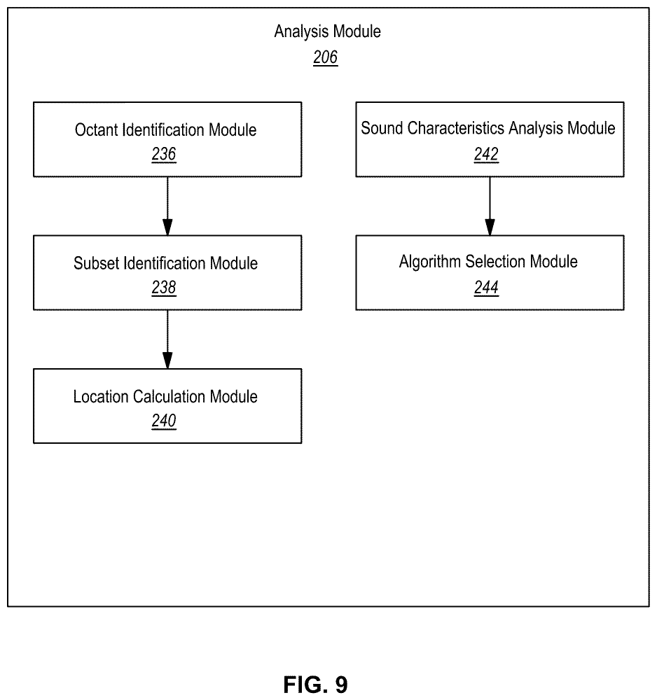

In one example, the analysis module 206 applies one or more time-of-arrival algorithms to process the recorded acoustic signals 208 and determine the location 212 of the acoustic source 210, based on the recorded acoustic signals 208 captured by the plurality of microphones 114. Referring to FIG. 9, the analysis module 206 utilizes an octant identification module 236 to analyzing the time differences of arrival for each microphone pair (e.g., +X axis coordinate, −X axis coordinate, +Y axis coordinate, −Y axis coordinate, +Z axis coordinate, −Z axis coordinate) to identify a localized octant where the acoustic source 210 is located, based on the time-of-arrival of the acoustic signals 204 from each one of the plurality of microphones 114 positioned along the first axis 108, the second axis 110, and the third axis 112. Once the localized octant is identified, the subset identification module 238 identifies a subset of the plurality of microphones 114 that define the localized octant. The subset of the plurality of microphones 114 includes the four microphones that surround the localized octant, specifically the origin microphone and a microphone from each axis. Utilizing the location calculation module 240, the algorithm then calculates spherical surfaces for each microphone pair based on the time difference and the speed of sound. The intersection of these spherical surfaces for each microphone pair determines the location 212 of the acoustic source 210. A quadratic equation is used to compute three parameters of the location 212 (i.e., intersection): azimuth (i.e., horizontal angle), elevation (i.e., vertical angle), which give the directional vector 218, and distance (D3) from the origin 116 to the acoustic source 210.

In some examples, the analysis module 206 is also configured to analyze the recorded acoustic signals 208 to determine a sound characteristic of the recorded acoustic signals 208, using the sound characteristic analysis module 242. That is, the acoustic signals are interrogated initially to determine the periodicity of the acoustic signals. The sound characteristic is one of a periodic sound source, such as from rotating equipment or electrical transformers, or a non-periodic sound source, such as impulses, snapping, clicking, air leaks, or speech. Based on the sound characteristic, an algorithm selection module 244 selects and applies one or more signal-processing algorithms 230. For example, a phased-array beamforming algorithm for periodic sound sources and a time-of-arrival algorithm for non-periodic sound sources.

Referring back to FIG. 7, in some examples, the acoustic source localization system 200 includes the visualization module 214, which is configured to display a graphical representation 216 of the location 212 of the acoustic source 210. As used herein, a graphical representation refers to any visual indication, symbol, or graphic used to convey the location 212 of the acoustic source 210 relative to an acoustic-testing space. The graphical representation 216 can include but is not limited to icons, markers, or diagrams that visually communicate the position of the acoustic source, allowing it to be observed in various context, such as through virtual displays or real-time environments. The graphical representation is not limited to a formal graph but rather any visual cue that helps a user identify the location 212. The visualization module 214 receives data from the analysis module 206, including the location 212, and uses this information to provide the graphical representation 216 of the location 212. In some examples, the graphical representation 216 may include a visual display of the acoustic array 100, showing the origin 116 and the axes, along with the calculated position of the acoustic source 210. The graphical representation 216 may include key details such as the direction vector 218 and the distance (D3) from the origin 116, enabling a visual reference of the location 212 of the acoustic source 210 within the acoustic-testing space.

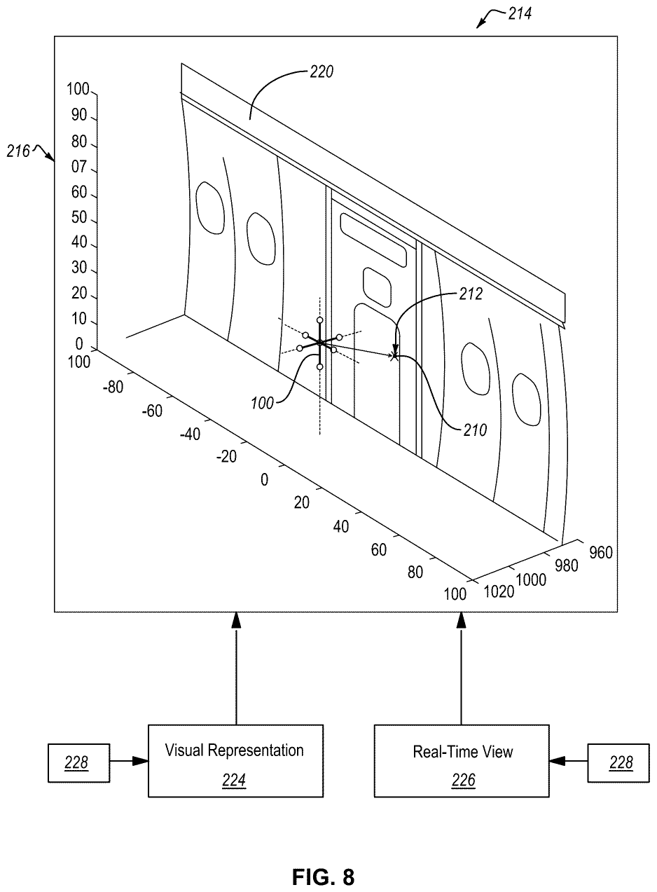

In some examples, the visualization module 214 including visualization data 220 that represents an acoustic-testing space 222 where the acoustic array 100 is configured to be deployed. Referring to FIG. 8, the visualization module 214 can display the graphical representation 216 of the location 212 of the acoustic source 210 relative to the visualization data 220. Visualization data 220 may include any information or dataset that is used to visually represent the acoustic-testing space 222 including, but not limited to, real-time images, virtual models, spatial layouts, or other forms of visual content. The visualization data 220 may be used to create both real-time views and virtual representations, providing context for the location 212 of the acoustic source 210 relative to its surrounding environment.

For example, in some implementations, the visualization data 220 includes a virtual representation 224 of the acoustic-testing space 222. This virtual representation can be viewed by a user 228 located remotely from the acoustic-testing space 222 using digital devices. The virtual representation 224 may be interactive and may be manipulated digitally by a user 228. This can be enhanced through advanced technologies such as Virtual Reality (VR) headsets, which combine the location 212 of the acoustic source 210 with a 3D model of the acoustic-testing space 222. This helps visualize the location 212 of the acoustic source 210. In this way, a user can visualize the acoustic source's location in 3D, even if they are not physically present. In some examples, structures that block visual access to interior structures or components may be made semi-transparent in the virtual environment to provide insight into hidden areas.

In other implementations, the visualization data 220 includes a real-time view 226 of the acoustic-testing space 222, capturing live conditions or sensor data within the acoustic-testing space 222. The real-time view 226 is captured from the acoustic-testing space 222, such as through cameras or sensors, and transmits that data to the user 228, who may be within the acoustic-testing space 222 or observing remotely. Through the use of cameras, VR headsets, or other projection devices, the visualization module 214 is configured to display the graphical representation 216 of the location 212 of the acoustic source 210 within the real-time view 226. Additionally, the real-time view 226 can be used with augmented reality (AR) technology, where the location 212 of the acoustic source 210 is virtually overlaid on the live image of the acoustic-testing space. This AR implementation may further enhance the user's ability to pinpoint the acoustic source by displaying virtual elements, such as digital representations of parts behind panels, offering more detailed insights into the surrounding environment.

In some examples, the data acquisition module 202, the analysis module 206, and the visualization module 214 may be implemented as hardware components, such as computer processors, microcontrollers, or any general-purpose computing devices. In some implementations, the modules may be separate devices or integrated into the same computing system.

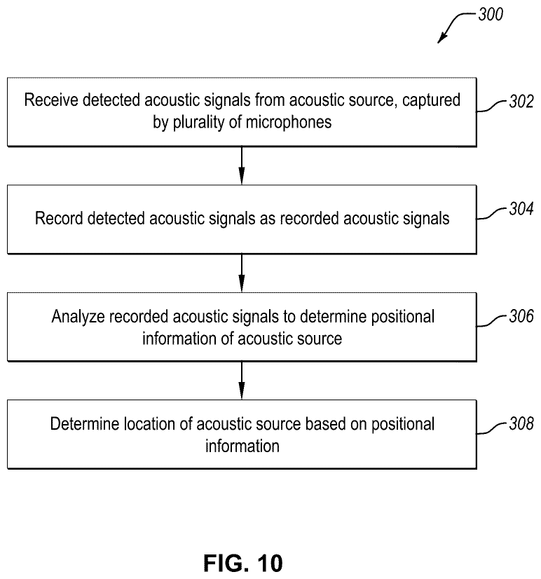

Referring to FIG. 10, and according to one example, a method 300 for localizing an acoustic source 210 is shown. The method 300 includes (block 302) receiving acoustic signals 204 from the acoustic source 210. The acoustic signals 204 are captured by the acoustic array 100 that includes the plurality of microphones 114, where each one of the microphones 114 is positioned along one of the first axis 108, the second axis 110, and the third axis 112. The plurality of microphones are coupled to the support assembly 102 of the acoustic array 100. The first axis 108, the second axis 110, and the third axis 112, may be orthogonal to each other to ensure that the acoustic array 100 captures sound from multiple directions, allowing for accurate localization of the acoustic source 210. By positioning the plurality of microphones 114 along different axes, the acoustic signals 204 can be received from multiple directions, ensuring more comprehensive data collection to determine the location 212 of the acoustic source 210.

The method 300 also includes (block 304) recording the acoustic signals 204 captured by the plurality of microphones 114 as recorded acoustic signals 208. Specifically, each one of the plurality of microphones 114, positioned along the first axis 108, the second axis 110, and the third axis 112, transmits their corresponding acoustic signals 204 to a data acquisition module 202. The data acquisition module 202 is configured to receive, record, and store the acoustic signals 204 as recorded acoustic signals 208, ensuring accurate capture of the acoustic data from all microphone positions for further analysis.

The method 300 further includes (block 306) analyzing the recorded acoustic signals 208 to determine positional information of the acoustic source relative to the origin defined by the intersection of the first axis 108, the second axis 110, and the third axis 112. Specifically, the analysis module 206 processes the recorded acoustic signals 208 using one or more signal-processing algorithms, such as time-of arrival algorithms or phased array beamforming algorithms, to calculate time differences in the arrival of sound between each microphone pair along the first axis 108, the second axis 110, and the third axis 112. This analysis generates the positional data for the directional vector 218 and the distance (D3), relative to the origin 116, helping identify a location 212 of the acoustic source 210.

The method 300 additionally includes (block 308) determining a location 212 of the acoustic source 210 based on the positional information. That is, the positional information, such as the directional vector 218 and the distance (D3) is used to compute the location 212 of the acoustic source 210. Once the location 212 is determined, the visualization module 214 can display the graphical representation 216 of the location 212 relative to the acoustic-testing space 222.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

The term “about” or “substantially” in some embodiments, is defined to mean within +/−5% of a given value, however in additional embodiments any disclosure of “about” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. An acoustic array for acoustic source localization, the acoustic array comprising:
a plurality of microphones, wherein:
each one of the plurality of microphones is positioned along at least one of a first axis, a second axis angled relative to the first axis, or a third axis angled relative to the first axis and the second axis;
a first microphone of the plurality of microphones is positioned at an origin of the acoustic array defined at an intersection of the first axis, the second axis, and the third axis; and
others of the plurality of microphones are positioned at a predetermined distance from the origin, with at least one of the plurality of microphones positioned along each one of the first axis, the second axis, and the third axis; and
a support assembly comprising:
a central mount; and
a plurality of support arms that extend outward from the central mount;
wherein:
each one of the plurality of microphones are coupled to either the central mount or one of the plurality of support arms;
ones of the plurality of microphones coupled to the central mount are positioned along the first axis; and
ones of the plurality of microphones coupled to a corresponding one of the plurality of support arms are positioned along the second axis or the third axis.

2. The acoustic array of claim 1, wherein:
the plurality of support arms comprises a first support arm and a second support arm;
the ones of the plurality of microphones coupled to the first support arm are positioned along the second axis; and
the ones of the plurality of microphones coupled to the second support arm are positioned along the third axis.

3. The acoustic array of claim 1, wherein:
the plurality of support arms comprises four support arms;
a first pair of the four support arms extends outward from the central mount such that the ones of the plurality of microphones coupled to the first pair of the four support arms are positioned along the second axis on opposing sides of the origin; and
a second pair of the four support arms extends outward from the central mount such that the ones of the plurality of microphones coupled to the second pair of the four support arms are positioned along the third axis on opposing sides of the origin.

4. The acoustic array of claim 1, wherein:
each one of the plurality of support arms is foldable relative to the central mount, such that the plurality of support arms are selectively movable between, and inclusive of, an extended position and a folded position;
when the plurality of support arms are in the extended position, the ones of the plurality of microphones coupled to the plurality of support arms are positioned along the second axis or the third axis; and
when the plurality of support arms are in the folded position, the ones of the plurality of microphones coupled to the plurality of support arms are not positioned along the second axis or the third axis.

5. The acoustic array of claim 1, wherein a length of each one of the plurality of support arms is adjustable to adjust the predetermined distance of a corresponding one of the plurality of microphones from the origin.

6. The acoustic array of claim 1, wherein the first axis is orthogonal to the second axis and the third axis is orthogonal to both the first axis and the second axis.

7. The acoustic array of claim 1, wherein the predetermined distance between the first microphone, positioned at the origin, and each one of the others of the plurality of microphones is the same.

8. The acoustic array of claim 1, wherein:
the plurality of microphones comprises seven microphones, including the first microphone positioned at the origin;
a first pair of microphones is positioned along the first axis on opposing sides of the origin;
a second pair of microphones is positioned along the second axis on opposing sides of the origin; and
a third pair of microphones is positioned along the third axis on opposing sides of the origin.

9. The acoustic array of claim 1, wherein the plurality of microphones are configured to provide directional acoustic coverage in at least one octant defined by the intersection of three planes formed by the first axis, the second axis, and the third axis.

10. The acoustic array of claim 1, wherein the plurality of microphones are configured to provide directional acoustic coverage in all directions to provide full spherical coverage.

11. The acoustic array of claim 1, wherein the plurality of microphones comprises at least one secondary microphone positioned along at least one of the first axis, the second axis, or the third axis, on a same side of the origin, at a second predetermined distance from the origin, as another one of the plurality of microphones, and wherein the second predetermined distance is different than the predetermined distance.

12. An acoustic source localization system, comprising:
an acoustic array, comprising:
a plurality of microphones; and
a support assembly configured to couple each one of the plurality of microphones along at least one of a first axis, a second axis angled relative to the first axis, or a third axis angled relative to the first axis and the second axis;
wherein:
a first microphone of the plurality of microphones is positioned at an origin of the acoustic array defined at an intersection of the first axis, the second axis, and the third axis; and
others of the plurality of microphones are positioned at a predetermined distance from the origin, with at least one of the plurality of microphones positioned along each one of the first axis, the second axis, and the third axis;
a data acquisition module operatively coupled to the plurality of microphones and configured to receive and record acoustic signals from the acoustic source, wherein the acoustic signals are captured by each one of the plurality of microphones and recorded as recorded acoustic signals; and
an analysis module configured to process the recorded acoustic signals from the data acquisition module and determine a location of the acoustic source based on the recorded acoustic signals, wherein the location comprises a directional vector and a distance, relative to the origin of the acoustic array.

13. The acoustic source localization system of claim 12, further comprising a visualization module configured to display a graphical representation of the location of the acoustic source.

14. The acoustic source localization system of claim 13, wherein the visualization module further comprises:
visualization data representing an acoustic-testing space where the acoustic array is configured to be deployed; and
the visualization module is configured to display the graphical representation of the location of the acoustic source relative to the visualization data.

15. The acoustic source localization system of claim 14, wherein:
the visualization data comprises a virtual representation of the acoustic-testing space, allowing the visualization data to be observed by a user located remotely from the acoustic-testing space; and
the visualization module is configured to display the graphical representation of the location of the acoustic source relative to the virtual representation of the acoustic-testing space.

16. The acoustic source localization system of claim 14, wherein:
the visualization data comprises a real-time view of the acoustic-testing space, allowing the visualization data to be observed by a user; and
the visualization module is configured to display the graphical representation of the location of the acoustic source relative to the real-time view of the acoustic-testing space.

17. The acoustic source localization system of claim 12, wherein the analysis module is further configured to determine the location of the acoustic source using one or more signal-processing algorithms, based on the recorded acoustic signals captured by the plurality of microphones, wherein the one or more signal-processing algorithms comprise at least one of a time-of-arrival algorithm or a phased array beamforming algorithm.

18. The acoustic source localization system of claim 12, wherein the analysis module is further configured to:
identify a localized octant where the acoustic source is located, based the acoustic signals received from each one of the plurality of microphones positioned along the first axis, the second axis, and the third axis;
identify a subset of the plurality of microphones that defines the localized octant; and
determine the location of the acoustic source within the localized octant, using one or more signal-processing algorithms, based on the recorded acoustic signals captured by the subset of the plurality of microphones, wherein the one or more signal-processing algorithms comprise at least one of a time-of-arrival algorithm or a phased array beamforming algorithm.

19. The acoustic source localization system of claim 12, wherein the analysis module is further configured to:
analyze the recorded acoustic signals to determine a sound characteristic of the recorded acoustic signals, wherein the sound characteristic is one of a periodic sound source or a non-periodic sound source; and
select and apply one or more signal-processing algorithms based on the sound characteristic, wherein at least one of the one or more signal-processing algorithms is configured for periodic sound sources and at least another one of the one or more signal-processing algorithms is configured for non-periodic sound sources.

20. A method for localizing an acoustic source, the method comprising:
receiving acoustic signals from the acoustic source, captured by a plurality of microphones positioned along each one a first axis, a second axis angled relative to the first axis, and a third axis angled relative to both the first axis and the second axis, wherein the plurality of microphones are coupled to a support assembly of an acoustic array;
recording the acoustic signals, captured by the plurality of microphones as recorded acoustic signals;
analyzing the recorded acoustic signals to determine positional information of the acoustic source relative to an origin defined by an intersection of the first axis, the second axis, and the third axis; and
determining a location of the acoustic source based on the positional information.
